(19) United States
(12) Patent Application Publication
(10) Pub. No.: US 2015/0221242 A1
(43) Pub. Date: Aug. 6, 2015

(54) COMPOSITE TAG

(71) Applicant: TAG APPEAL, LLC, Madison, NJ (US)

(72) Inventors: Ellen Cable, Madison, NJ (US); Robert Silver, Madison, NJ (US); Alex Ezra Cable, Newton, NJ (US)

(21) Appl. No.: 14/689,876

(22) Filed: Apr. 17, 2015

Related U.S. Application Data
(63) Continuation-in-part of application No. 13/947,030, filed on Jul. 20, 2013.
Application No. 13/947,030 is a continuation-in-part of application No. 13/534,176, filed on Jun. 27, 2012, now Pat. No. 8,510,977.
(60) Provisional application No. 62/114,271, filed on Feb. 10, 2015.

(51) Int. Cl. G09F 3/04; G09F 7/04; B23K 26/36; A44B 15/00

(52) U.S. Cl. CPC G09F 3/04; A44B 15/005; G09F 7/04; B23K 26/365; G09F 2003/0257

(57) ABSTRACT

One embodiment of a composite tag comprises a first inner panel having a first surface and a second surface, a second outer panel having an inner surface and an outer surface and being magnetically attached to the first surface of the first inner panel, a third outer panel having an inner surface and an outer surface and being magnetically attached to the second surface of the first inner panel.

### CROSS-REFERENCE TO RELATED APPLICATIONS

This application is a continuation in part of U.S. application Ser. No. 13/947,030 filed on Jul. 20, 2013, which is a continuation-in-part of U.S. application Ser. No. 13/534,176, filed on Jun. 27, 2012, now U.S. Pat. No. 8,510,977, issued Aug. 20, 2013, the contents of each of which are incorporated by reference herein. This application also claims the benefit of U.S. Application 62/114,271, filed Feb. 10, 2015, the contents of which are incorporated by reference herein.

### FIELD

The present invention relates to the field of tags that are attachable for identification and/or decorative purposes to personal items, such as key chains, backpacks, laptop computers, cell phones, briefcases, luggage, articles of clothing, or people. More specifically, the present invention relates to such tags wherein the identification and/or decorative elements are replaceable and/or interchangeable magnetic panels.

### BACKGROUND

The use of attachable tags to identify the owner of personal items and/or to enhance their appearance is widespread and growing with the proliferation of portable electronic devices. Such tags have also increasingly become items of personal style, through which the owner can display his/her interests in sports, music and other aspects of popular culture. For example, a high school athlete might want to have a tag depicting lacrosse sticks attached to his/her sports bag when he/she is participating in a lacrosse match. But the same athlete might want to have his/her bag tag display a basketball when he/she is participating in that sport. It would therefore be advantageous to have a tag in which the identification/decorative elements are interchangeable, so that a single tag could serve multiple purposes and display multiple interests of the owner.

One embodiment of the present disclosure provides a tag with a composite structure comprising two indicia-bearing magnetic panels, which are removably attachable to a central plate or panel containing a magnetic material. In use in one embodiment, the central plate is retained, while the outer panels can be interchanged to alter the outward appearance of the tag as desired.

### SUMMARY

One embodiment of the present invention is a tripartite composite magnetic tag, comprising two substantially congruent outer panels that are magnetically attached to a substantially congruent central panel. The magnetic outer panels can comprise either a single magnetic layer or a composite of a magnetic interior layer bonded to or coated by a non-magnetic exterior layer. In one embodiment, the central panel substantially conforms to the size and shape of the two magnetic outer panels. In one embodiment, the central panel can be made of one or more ferromagnetic materials, such as stainless steel, or can be a composite comprising a non-ferromagnetic core that is coated, encased or surrounded by one or more ferromagnetic materials. In one embodiment, the central panel can be made from a non-ferromagnetic material that encases or surrounds one or more ferromagnetic materials.

In one embodiment, each of the two outer panels attaches by its magnetic layer to either face of the central panel, thereby forming a composite “sandwich” tag, in which the exterior sides of the magnetic outer panels are visible. In one embodiment, each of the two outer panels can have one or more apertures or openings, each of which aligns cooperatively with corresponding apertures of the other outer panel and of the central panel to form a composite aperture or passage, such that the assembled composite tag can be attached to one or more other items by a connective means, such as a cord, ring, chain or clip, inserted through one or more of the composite apertures or passage.

In one embodiment, any or all of the panels can contain graphic and/or alphanumeric indicia, including but not limited to: photographs, pictures, artwork, text, calligraphy, or visually encoded data, such as barcodes or QR codes. Such indicia may be incorporated through one or more methods, including but not limited to printing, engraving, laser marking, etching, offset printing, dye sublimation, heat transfer, painting, imprinting, stamping, manual or pre-applied adhesive, marker, handwriting, injection molding, labeling, foil stamping, 3D printing or holographic printing. Other methods are contemplated. The incorporated indicia can be used to convey information, including but not limited to the following: (a) contact information about an individual or organization, such as a name and/or address; (b) a message; (c) a quotation, poetry or literary passage; (d) one or more identifiers which represent an individual, such as a customer number; (e) an internet address, email address, phone number or other identifier, locator or contact method for a person, organization, or web page; (f) medical information, such as a list of allergies or medical history; or (g) information regarding a pet, such as a dog's owner's information. Other information in the form of scannable or readable information may be incorporated into a panel.

One embodiment of a tripartite composite magnetic tag of the present invention can function as an identification device for bags or luggage, pets, or items, as a keychain, as a conveyance for medical information in textual form, as a conveyance for visually-encoded data, such as QR codes or barcodes, which represent data stored elsewhere, or as a customizable item, in which the central panel and outer panels are customized with photos, images, or text. The various panels can also function as membership cards, loyalty cards, payment cards, coupons, coupon cards, and the like.

The composite magnetic tag can have any one of a variety of shapes and contours, including but not limited to basic geometric shapes, such as a circle, square, triangle, rhombus or heart; or complex shapes, such as an apple, dog, tree or person. Optionally, either or both of the magnetic outer panels can contain a window or opening through which central plate can be viewed. Various embodiments describing various features are also described.

The foregoing summarizes the general design features of the present invention. In the following sections, a specific embodiment of the present invention will be described in some detail. This specific embodiment is intended to demonstrate the feasibility of implementing the present invention in accordance with the general design features discussed above. Therefore, the detailed description of this embodiment is offered for illustrative and exemplary purposes only, and it is not intended to limit the scope either of the foregoing summary description or of the claims which follow.

### BRIEF DESCRIPTION OF THE DRAWINGS

FIG. 1A is a front perspective view and FIG. 1B is an exploded view of one embodiment of a composite tag of the present disclosure;

FIG. 2A is a rear perspective view and FIG. 2B is an exploded view of one embodiment of a composite tag of the present disclosure;

FIG. 3 is a side view of one embodiment of a composite tag illustrating the removal of portions of the outer panels from the inner panel;

FIGS. 4A-4C illustrate alternate embodiments of a panel of the present disclosure;

FIG. 5A is a front perspective view and FIG. 5B is an exploded view of one embodiment of a composite tag of the present disclosure;

FIGS. 6A-6H illustrate one embodiment of a composite tag of the present disclosure;

FIG. 7 illustrates one embodiment of a composite tag of the present disclosure;

FIG. 8 illustrates one embodiment of a composite tag of the present disclosure;

FIG. 9 illustrates one embodiment of a composite tag of the present disclosure;

FIG. 10A is a front view and FIG. 10B is a cross-section taken along line 10B-10B of FIG. 10A of one embodiment of a panel of the present disclosure;

FIG. 11 illustrates one embodiment of a panel of the present disclosure;

FIG. 12 illustrates one embodiment of a panel of the present disclosure;

FIG. 13 illustrates one embodiment of a panel of the present disclosure;

FIG. 14 illustrates one embodiment of a panel of the present disclosure;

FIG. 15 illustrates one embodiment of a network-connected panel of the present disclosure;

FIG. 16 illustrates one embodiment of a panel of the present disclosure;

FIG. 17 illustrates one embodiment of a composite tag of the present disclosure;

FIG. 18 illustrates one embodiment of a panel of the present disclosure;

FIGS. 19A and 19B illustrate alternate embodiments of a panel of the present disclosure;

FIGS. 20A-20C illustrate one method of forming a writing surface on one embodiment of a panel of the present disclosure;

FIG. 21 illustrates one embodiment of a kit including components to form a composite tag;

FIG. 22 illustrates one embodiment of a kit including components to form a composite tag;

FIG. 23 illustrates one embodiment of a composite tag of the present disclosure;

FIG. 24 illustrates one embodiment of a composite tag of the present disclosure; and

FIG. 25 illustrates one embodiment of a composite tag of the present disclosure.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

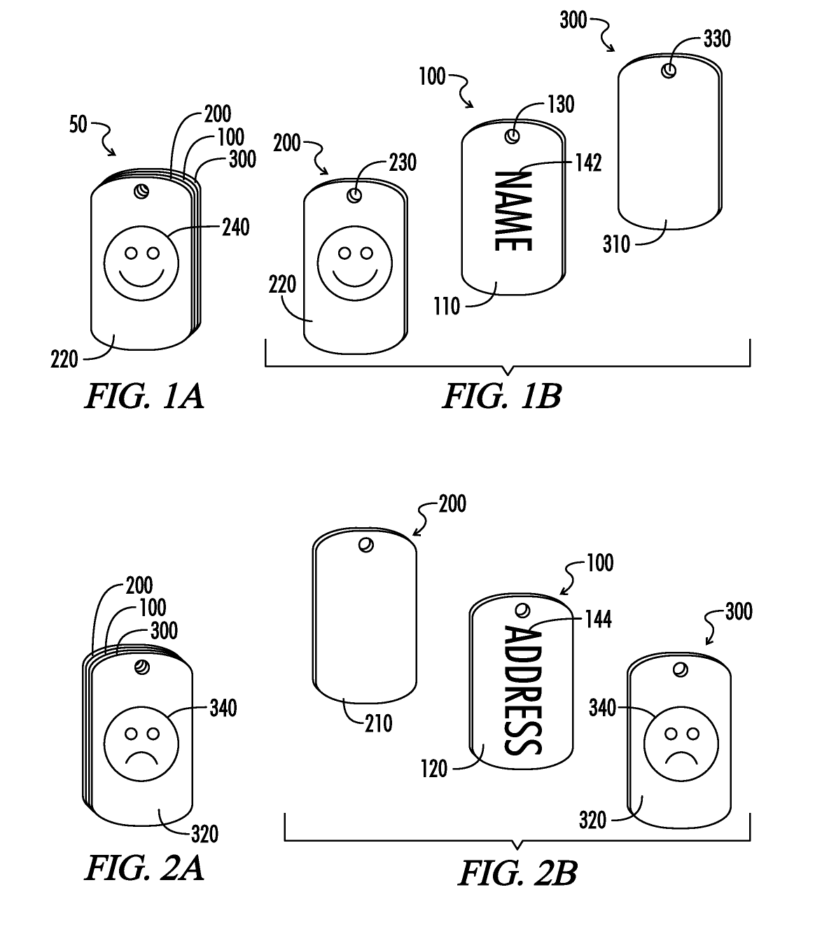

FIG. 1A is a front perspective view and FIG. 1B is an exploded view of one embodiment of an assembled composite tag 50 having a first inner panel 100 and second and third outer panels 200, 300 attached to the first inner panel 100, with the first inner panel 100 preferably substantially conforming to the size and shape of the two outer panels 200, 300. FIG. 2A is a rear perspective view and FIG. 2B is an exploded view of the embodiment of the composite tag 50 of FIGS. 1A-1B. While the inner panel 100 and outer panels 200, 300 are illustrated with a certain shape, construction, dimensional configuration and thickness, it will be appreciated that each panel may have a different shape, construction, dimensional configuration and thickness, or that certain panels may be similarly configured while other panels may be different, or that certain panels may have only certain similar features. For example, the panels may have geometric shapes, or shapes representing the outline of an object, symbol, plant, animal, person, etc. Other shapes are possible. In addition, while various embodiments of panels are described herein, it will be appreciated that any of the panels described herein may be used in combination with any of the other panels described herein, or with embodiments of panels not described herein, or with multiples of panels or panel combinations, to form a composite tag. The illustrations, depictions and descriptions provided herein are not meant to be limiting, but merely illustrative and explanative, it being understood that other configurations and constructions are possible. Further, while three panels are shown and described in the various embodiments, it will be appreciated that a composite tag having only two panels or more than three panels may be possible.

In the embodiment of FIGS. 1A-2B, the first inner panel 100 preferably comprises a first surface 110, a second surface 120, an opening 130 and indicia 142 provided on the first surface 110 and indicia 144 provided on the second surface 120. The second outer panel 200 also preferably comprises a first surface 210, a second surface 220, an opening 230 and indicia 240. The third outer panel 300 also preferably comprises a first surface 310, a second surface 320, an opening 330 and indicia 340. While indicia 142, 144, 240, 340 is shown and described on the various surfaces, it will be appreciated that the indicia is optional, and one or more or all of the various surfaces may be devoid of indicia such as text, drawings, pictures, imagery, branding and the like. Certain panels and/or surfaces may, for example, only be differentiated by color, texture, shape, thickness, configuration, material property, functionality or utilitarian feature. Other methods of differentiation may be possible.

In a preferred embodiment, each of the second and third outer panels 200, 300 is magnetically attached to the first inner panel 100 such that the outer panels may be easily interchanged with other outer panels as described herein, but where the second and third outer panels 200, 300 remain securely attached to the first inner panel during normal use and carrying. In a preferred embodiment, the inner surface 210 of the second outer panel 200 is magnetically attracted to the first surface 110 of the first inner panel 100, while the inner surface 310 of the third outer panel 300 is magnetically attracted to the second surface 120 of the first inner panel 100, while the outer surfaces 220, 320 of the outer panels 200, 300 are preferably not magnetic and are preferably provided with some form of indicia or ornamentation 240, 340. In a preferred embodiment of the outer panels 200, 300, the inner surfaces 210, 310 are preferably formed from magnetic layers that are bonded to non-magnetic exterior layers 220, 320, or non-magnetic outer surfaces 220, 320 are coated onto magnetic inner surfaces 210, 310. In one embodiment, an outer panel may be formed from a non-magnetic material such as plastic, and have sandwiched or embedded within the material of the panel magnetics, magnetic elements or magnetic particles. Various other constructions and configurations are possible.

In a preferred embodiment, the first inner panel 100 is preferably rigid to create a rigid substructure for the second and third outer panels 200, 300. In one embodiment, the first inner panel is constructed from a thin gauge metal such as stainless steel, although other materials or combinations of materials are possible. The level of rigidity may vary depending on the material, construction and thickness of the first inner panel 100. In one embodiment, the first inner panel 100 is formed of a magnetic stainless steel such as 430-series stainless steel. Other materials or combinations of materials may be used. In one preferred embodiment, the first inner panel 100 is formed from a material that is attracted to a magnet, and in particular to attract the magnetic inner surfaces 210, 310 of the outer panels 200, 300 respectively. In an alternate embodiment, the magnetism of the panels may be reversed, wherein the outer panels 200, 300 may be formed from magnetic material such as magnetic stainless steel to which the inner panel 100 is magnetically attracted. In an alternate embodiment, the inner panel 100 may be formed from a metal that is not actually magnetic, but that has magnetic-attracting properties that attracts the outer panels 200, 300 to form a composite tag 50. In one embodiment, the composite tag is sized and shaped to be worn on a key ring, or used as a luggage tag, or it can have other uses. In one non-limiting example, the tag further comprises a long-side length of 1.5 to 3 inches and short-side width of 0.75 to 2 inches. Other dimensions are contemplated.

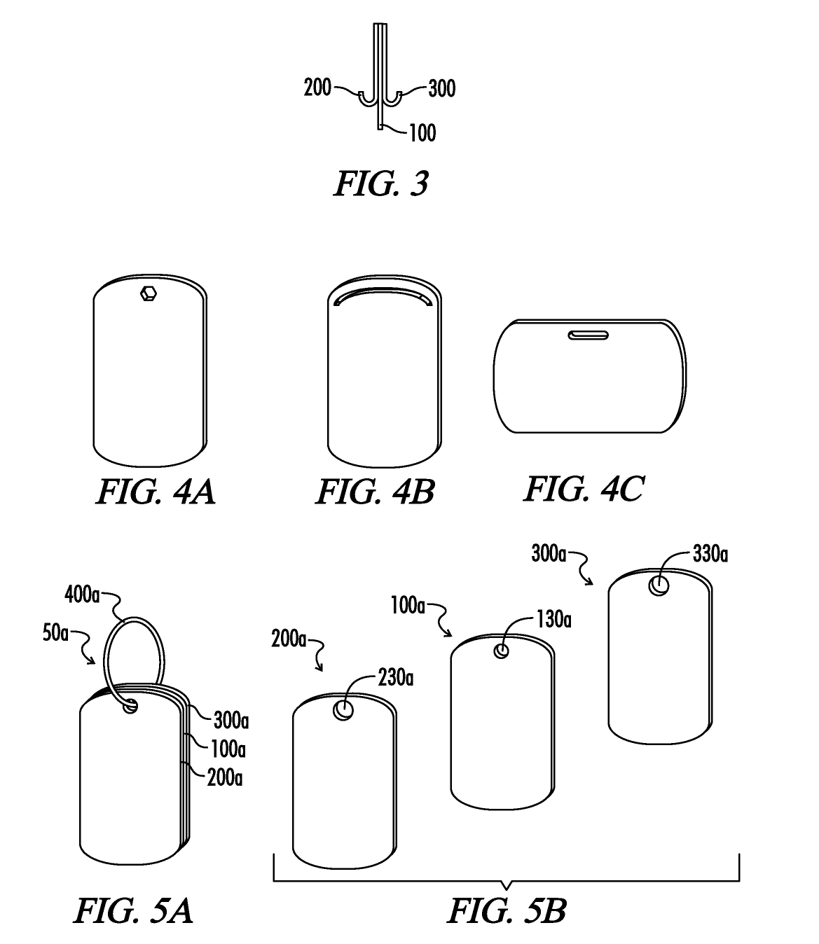

In one embodiment, the outer panels 200, 300 are not as rigid as the inner panel 100, and are more flexible than the inner panel 100, such that the outer panels 200, 300 may be peeled off (FIG. 3) the inner panel 100 when it is desired to separate the outer panels 200, 300 from the inner panel. In an alternate embodiment, the second and third panels 200, 300 are rigid and are sandwiched around a flexible inner panel 100. The rigidity of each panel may be adjusted by adjusting the constructional and material properties of each panel, and various combinations of rigid, semi-rigid and flexible panel constructions may be used.

In the embodiment of FIGS. 1A-2B, the first inner panel 100 includes an opening 130 that cooperatively aligns with openings 230, 330 in the outer panels 200, 300 to form a passage through the panels for receiving a carrying member such as a key ring, luggage strap, chain or the like. In the embodiment of FIGS. 1A-2B, each opening is circular and is aligned with the longitudinal axis of its respective panel. However, other non-circular shapes and configurations are possible including, but not limited to a non-circular opening such as a hexagonal opening (FIG. 4A), an arcuate opening (FIG. 4B), or an oval opening aligned along a lateral axis of a panel (FIG. 4C). Other shapes, configurations and orientations are contemplated.

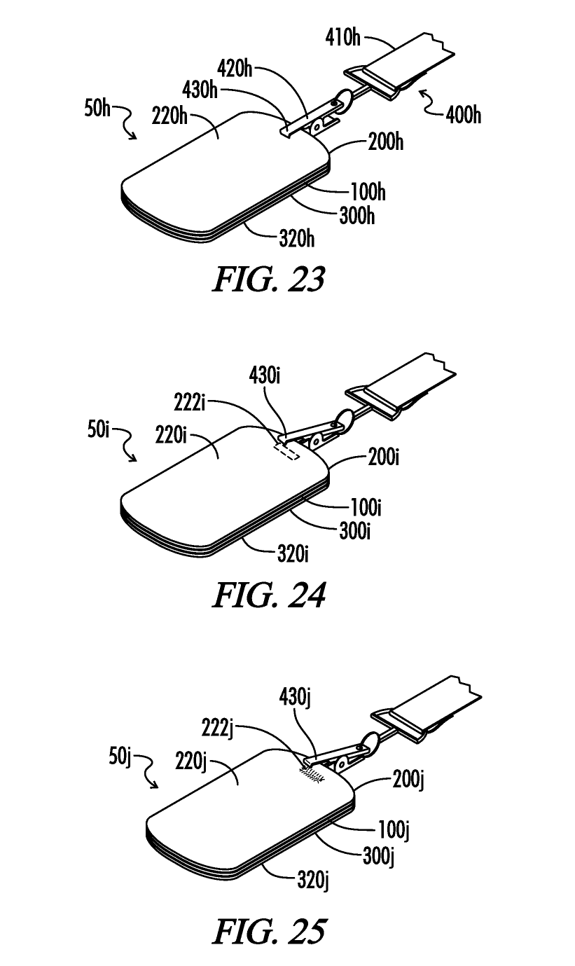

FIG. 5A is a front perspective view and FIG. 5B is an exploded view of one embodiment of an assembled composite tag 50a having a first inner panel 100a and second and third outer panels 200a, 300a attached to the first inner panel 100a and the three panels being joined together by a carrying member 400a that extends through openings 130a-330a. In the embodiment of FIGS. 5A-5B, the outer panels 200a, 300a have larger openings 230a, 330a than the opening 130a on the inner panel 100a to enable greater movement of the outer panels 200a, 300a relative to the inner panel 100a while the panels are bound together with the carrying member 400a, with the first inner panel 100a preferably substantially conforming to the size and shape of the two outer panels 200a, 300a. While the embodiments of FIGS. 1A-5B illustrate openings on each panel, it is not necessary for each panel to have an opening to accommodate a carrying member or otherwise. In one embodiment (see, for example, FIGS. 23-25), the panels may be devoid of openings and only attached together through the alignment of the outer peripheral edges of the panels or the use of a clamp or carrying member or both. Other embodiments are possible.

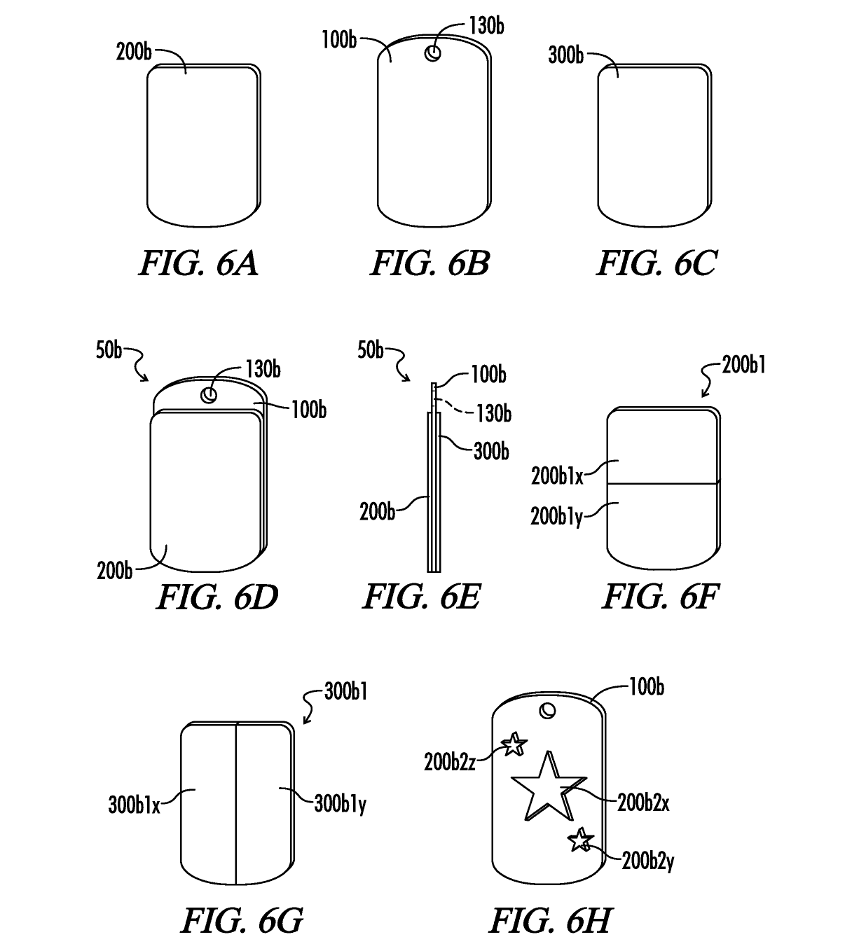

FIGS. 6A-6H illustrate one embodiment of a composite tag 50b having an inner panel 100b with opening 130b and outer panels 200b, 300b with no openings. In this embodiment, the outer panels 200b, 300b are shorter than the inner panel 100b so as not to occlude the opening 130b, and the opening 130b on the inner panel 100b is used for the attachment of a carrying member for carrying the tag 50b. FIG. 6F illustrates a bifurcated outer panel 200b1 having vertically-arranged panel segments 200b1x and 200b1y, while FIG. 6G illustrates a bifurcated outer panel 300b1 having horizontally-arranged panel segments 300b1x and 300b1y. FIGS. 6F-6G illustrate that the outer panels can comprise more than one panel segment, or a plurality or numerous different panel segments, wherein each segment may have a different appearance, construction, configuration, material composition and so on. While FIGS. 6F-6G illustrate adjoining panel segments, it is not necessary for the panel segments to be adjoining, or near each other, in the event the panel segments are appropriately sized. For example, FIG. 6H illustrates inner panel 100b adorned or decorated by a plurality of outer panel segments 200b2x-200b2z. While FIG. 6H illustrates three outer panel segments, an outer panel can be formed by one or more or any number of panel segments.

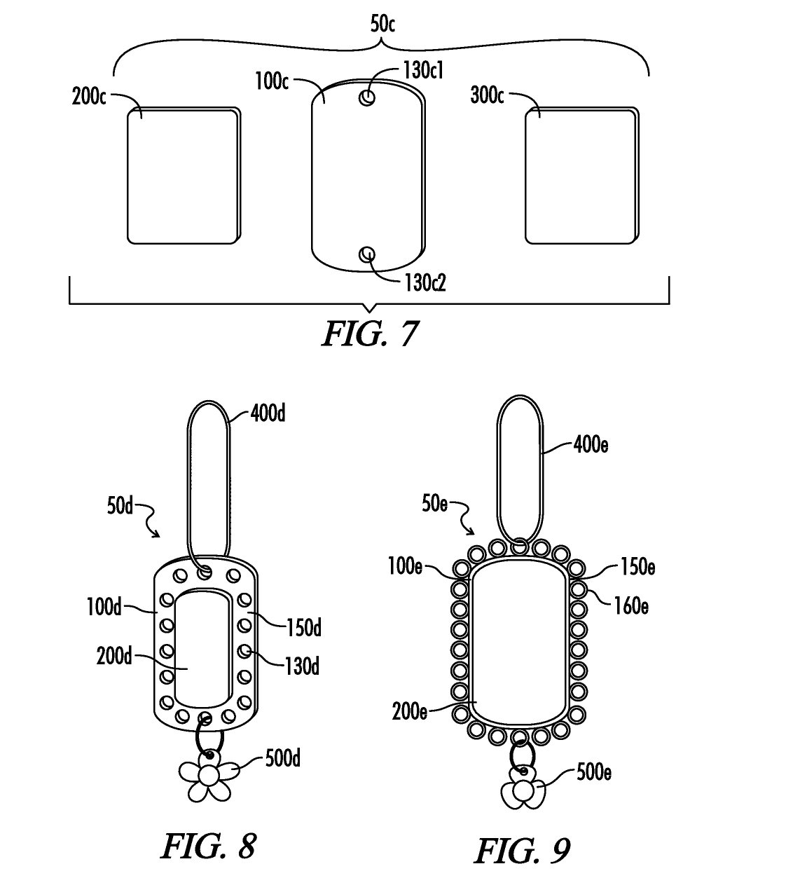

FIG. 7 illustrates one embodiment of a composite tag 50c having an inner panel 100c with a plurality of openings 130c1, 130c2 and outer panels 200c, 300c with no openings. In this embodiment, the outer panels 200c, 300c are shorter than the inner panel 100c so as not to occlude the openings 130c1, 130c2, and wherein either opening 130c1, 130c2 on the inner panel 100c may be used for the attachment of a carrying member for carrying the tag 50c. In one embodiment, one of the openings 130c1 may be used for a carrying member (not shown), while the other opening 130c2 may be used for attachment of a decoration such as a charm (not shown), or vice versa. Other configurations are possible.

FIG. 8 illustrates one embodiment of a composite tag 50d having an inner panel 100d with a plurality of openings 130d arranged around an outer periphery 150d of the inner panel 100d, and an outer panel 200d that is attached to the inner panel 100d so as to not occlude the openings 130d. The peripheral openings 130d are fashioned into the body of the inner panel 100d so that any one of the openings 130d may be used for attachment to a carrying member 400d such as a strap or a necklace, or for attachment to a decoration 500d such as a charm, or for anything else capable of being secured to one or more of the openings 130d. In one embodiment, the uppermost opening may be used for attachment to a carrying member, while the remainder of the openings may be used for attachment to a plurality of decorative charms. Other decorative variations are possible. The embodiment of FIG. 8 may or may not also comprise an additional outer panel in addition to outer panel 200d.

FIG. 9 illustrates one embodiment of a composite tag 50e having an inner panel 100e with a plurality of rings 160e arranged around an outer periphery 150e of the inner panel 100e, and an outer panel 200e that is attached to the inner panel 100e so as to not occlude the rings 160e. In this embodiment, the inner panel 100e does not have an opening fashioned into the panel, but instead has a plurality of protruding peripheral rings 160e, any one of which may be used for attachment to a carrying member 400e such as a strap or a necklace, or for attachment to a decoration 500e such as a charm. In one embodiment, the uppermost ring 160e may be used for attachment to a carrying member 400e, while the remainder of the rings 160e may be used for attachment to a plurality of decorative charms 500e. Other decorative variations are possible. The embodiment of FIG. 9 may or may not also comprise an additional outer panel in addition to outer panel 200e.

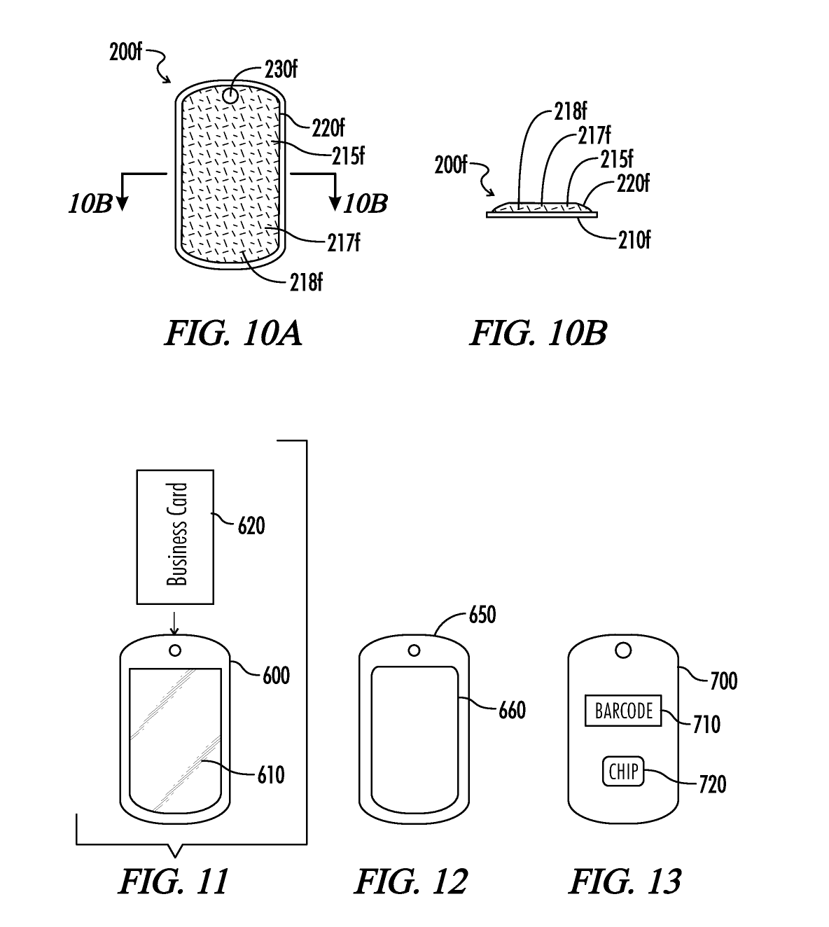

In one embodiment, each panel may be decorated, adorned or provided with indicia as desired by the user. In other embodiments, only certain panels are provided with indicia or the like. Each panel may also be configured with different tactile features depending on the materials used to form the panels. For example, in one embodiment of an outer panel having a magnetic inner surface, the outer surface may be formed from plastic, paper, cloth, metal, wood, glass or any material that is hard, soft, smooth, shiny, flexible, reflective, resilient, compressible, or the like. FIG. 10A is a top view and FIG. 10B is a cross-section taken along line 10B-10B of FIG. 10A, of an outer panel 200f having an opening 230f, preferably a magnetic inner surface 210f, and a domed outer surface 220f bounding an interior 215f having a compressible material 217f such as air, resin, a liquid or a gel that may or may not have further decoration such as glitter 218f or the like. Other decorative configurations are possible.

In addition to providing decorative features, an inner or outer panel may further comprise one or more function features. For example, FIG. 11 illustrates one embodiment of a panel 600 having a pocket 610 for receiving an object such as a business card 620 or the like. The pocket 610 may be opaque, translucent or preferably transparent if it is desired to have the inserted object be visible through the pocket.

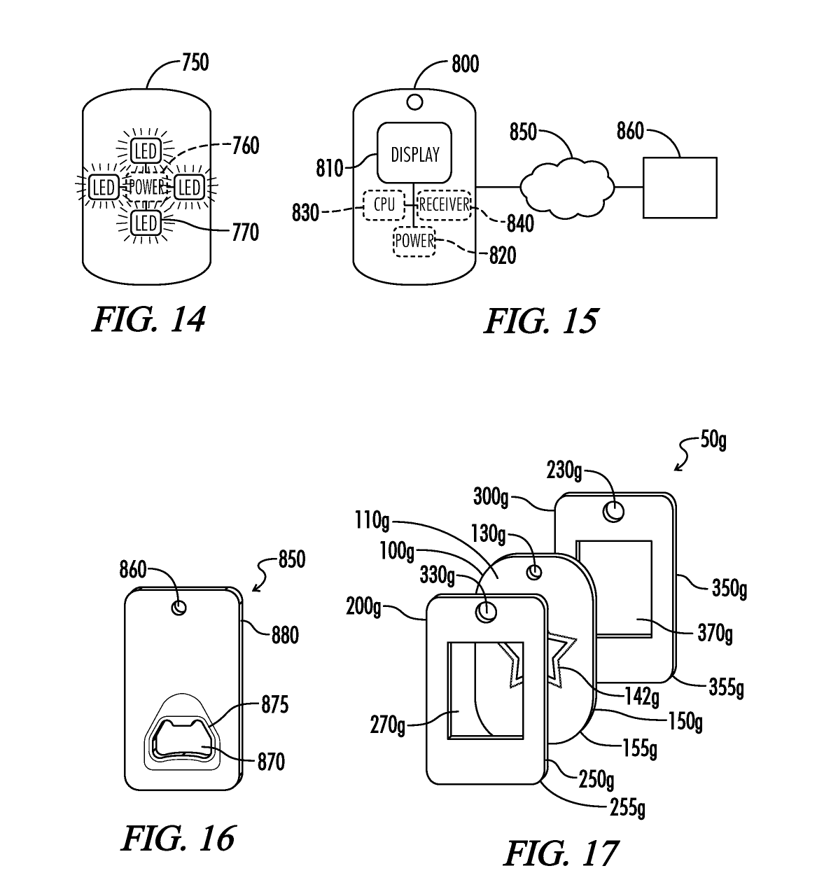

FIG. 12 illustrates one embodiment of a panel 650 that functions as a security or communication device having a scannable or readable feature such as a near field communication (NFC) loop antenna 660 embedded within the body of the panel 650 that is read by a proximity reader (not shown). FIG. 13 illustrates one embodiment of a panel 700 having a barcode 710 such as a UPC symbol, 3D barcode, 2D barcode, QR code, etc., and/or microchip 720 for communication with a scanner of some sort including, but not limited to, a barcode reader, RFID reader/scanner, and the like. The embodiments of FIGS. 12-13 illustrate features that enable the panel 650, 700 to also function as an electronic identification device. FIG. 14 illustrates one embodiment of a panel 750 having a power source 760 and one or more light devices 770 for illuminating the panel 750. The illumination devices 770 can be a variety of types including, but not limited to LEDs, OLEDs, edge lighting, and other types. Additional embodiments are contemplated that include various other electronics including, but not limited to, RFID chips, GPS, Bluetooth® capability, storage and memory. Further, security features can be incorporated into the panels that include biometric readers, passcode readers, or physical security features such as locks and the like.

FIG. 15 illustrates one embodiment of a panel 800 having a powered display 810 that is powered by a power source 820, controlled by a controller 830, and wherein information to be displayed on the display 810 is received via a receiver 840, preferably through a wireless network 850, from a device 860 that may be a software application on a mobile device or some other device or system that transmits information to the receiver 840 for controlling the display 810. In one example, the display 810 may show a plurality of photos that are stored in a memory (not shown) in the panel 800, or the display 810 may be customized by programming a microchip in the panel 800, or by receiving other information or instructions for display on the panel display 810 or for interaction between the user and the panel 800. In another embodiment (not shown), the panel may incorporate electronics that enable it to function as a controller for controlling devices or systems external to the panel.

FIG. 16 illustrates one embodiment of a panel 850 having a first opening 860 for receiving a carrying member (not shown) and a second opening 870 along other than the peripheral edge 880. In the embodiment of FIG. 16, the second opening 870 functions as a bottle opener and may have a reinforced border 875 to protect the panel surfaces from scratching or the like. While the second opening 870 in this embodiment contributes a functional benefit, additional openings may be strategically provided to provide other benefits. Such additional openings may, in one embodiment (not shown), cooperatively align with openings present in other panels.

The embodiment of FIG. 17, for example, illustrates a composite tag 50g having a first inner panel 100g with indicia 142g on a first surface 110g that is viewable through a window 270g in a second outer panel 200g, the third outer panel 300g also provided with a window 370g in this embodiment. The windows 270g, 370g may be formed from a translucent, semi-transparent or transparent material or surface or the windows may simply be openings in the panels 200g, 300g. Various configurations and combinations of structures may be possible wherein, for example, only one of the outer panels may include a window. The composite tag 50g of the embodiment of FIG. 17 also includes outer panels 200g and 300g that have a different shape than the inner panel 100g, and openings 230g and 330g that are larger than opening 130g of the first panel 100g. While the shape of the outer panels 200g and 300g substantially conforms to the shape of the inner panel 100g, the corners 255g, 355g along the periphery 250g, 350g of the outer panels 200g, 300g form a peripheral protrusion and overhang the corners 155g of the periphery 150g of the inner panel 100g, which enables a user to more easily access corners 255g, 355g for removal of the outer panels 200g, 300g relative to the inner panel 100g. While the embodiment of FIG. 17 shows outer panel corners that provide finger access around the entire periphery of the outer panels, it will be appreciated that there may only be one outer panel corner that provides finger access, with the other outer panels being flush with the inner panel at such other corners. Other configuration variations and combinations are possible.

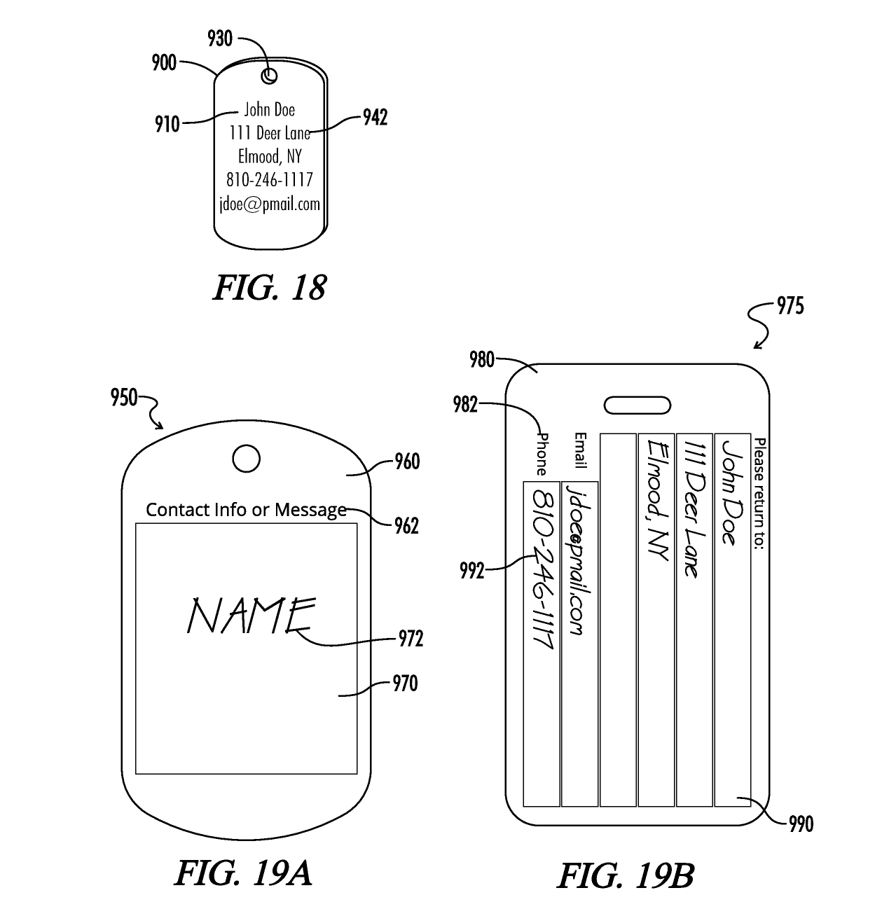

In a preferred embodiment, the first inner panel 100 is preferably used to carry identifying information about the user or owner of the composite tag 50. FIG. 18 illustrates one embodiment of an inner panel 900 having an opening 930 and a first surface 910 with indicia 942 pre-printed or engraved thereon. However, instead of having pre-printed indicia 942, it may be desirable to provide a panel surface that is configured to allow for writing with a pen, pencil, marker or the like, or that is configured to accept an adhesive such as a sticker or the like. For example, in the embodiment of FIG. 19A, a panel 950 is provided with a first surface 960 having a first indicia 962 pre-printed or laser engraved thereon, and a second surface 970 that is configured to receive a handwritten second indicia 972 thereon. The second surface 970 is also configured to receive other objects such as stickers or the like. Similarly, in the embodiment of FIG. 19B, a panel 975 is provided with a first surface 980 having a first indicia 982 pre-printed or laser engraved thereon, and a second surface 990 that is configured to receive a handwritten second indicia 992 thereon. In one embodiment, such information may include, but not be limited to identifying information such as the owner's name, address, phone and/or e-mail, and such identifying information may be concealed from view by covering the panel 975 with an outer panel. In the embodiments of FIGS. 19A and 19B, the first surfaces 960, 980 might be configured such that it would be difficult to write on such surfaces with a marker, such as if the surfaces are shiny metal, or powder coated, or otherwise configured to resist the adhesion of ink or some other marking material. At the same time, the second surfaces 970, 990 might be configured or roughened to enhance the adhesion of ink or some other marking material.

To facilitate the use of writing implements including, but not limited to those available from Sharpie® for example, on surfaces that are coated with various coating surfaces, and/or that are relatively impenetrable/impervious to inks or other marking materials used in writing implements, it is advantageous to roughen the surface to enhance the adhesion of the ink or marking materials. Many common materials or coatings are formulated so as to protect a part from absorbing contaminates that would discolor or stain them, examples include, but are not limited to plain steel coated with two part epoxy paints, UV curable paints, or powder coated coatings. Other materials, coatings and formulations are possible. There are times, however, when some region of these stain-resistant or stain-resistant coated surfaces is desired to be used as a region upon which a writing implement could be used to add handwritten or printed markings. As the surfaces are by choice stain resistant, some alteration is required to locally alter the stain resistance of the component. There are a number of methods through which a portion of an uncoated or coated substrate can be altered so as to accept common marker inks, or inks from other writing instruments such as ballpoint pens, gel pens, highlighters and the like. Such methods typically require the use of a tool or device to transform the surface or the surface coating from a smooth relatively non-porous surface to a textured surface with microscopic structure or roughness.

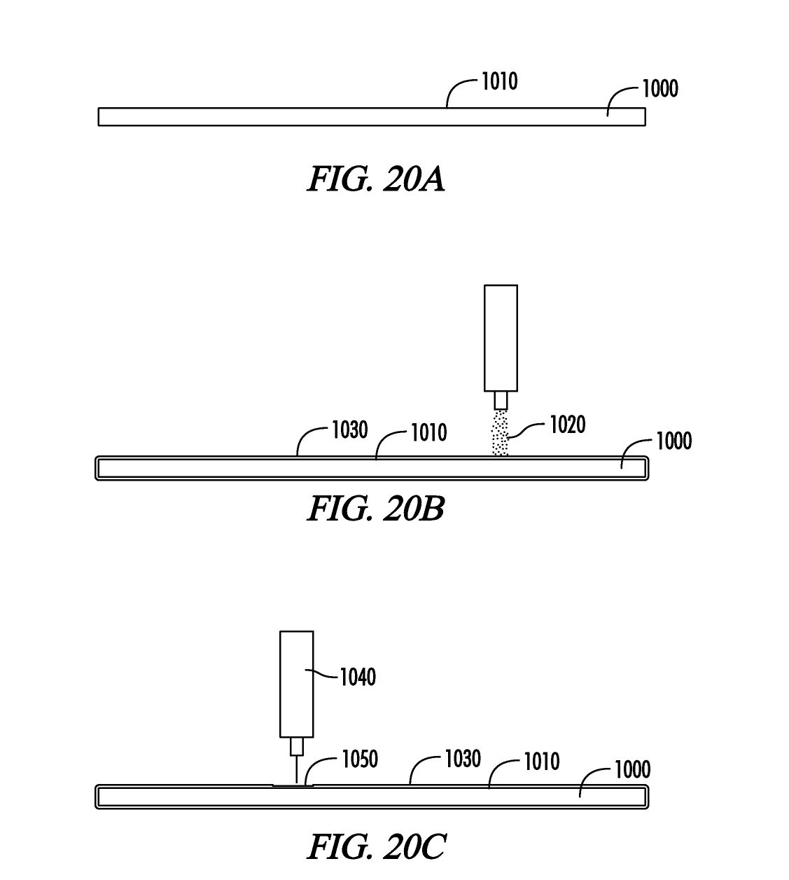

FIGS. 20A-20C illustrate one method of forming a writing surface on a panel 1000 comprising providing a panel 1000 having an outer surface 1010 (FIG. 20A), coating the outer surface 1010 of the panel 1000 with a coating 1020 that is preferably stain-resistant and/or that resists the adhesion of ink to form a coated outer surface 1030 (FIG. 20B; see also surface 980 of FIG. 19B), and then altering at least a portion of the coated outer surface 1030 with an altering device 1040 to form an altered outer surface 1050 (FIG. 20C; see also surface 990 of FIG. 19B) that is configured to be a writing surface and that accepts common inks (see indicia 992 of FIG. 19B), pencil and the like. Such altered surface may also be used to accommodate direct printing that would otherwise not be possible or optimal on a non-treated or non-prepared surface. Of course, while an inner panel is described, it will be appreciated that the illustrated method can be used with any inner or outer panel. As noted above, a variety of different materials can be used as the coating 1020 and to create a coated surface 1030. In a preferred embodiment, the coated outer surface 1030 is preferably powder coated to create a smooth surface to the touch and to reduce the friction between the panels in order to enhance the relative sliding of panels in the event it is desired to slide two panels apart to reveal various indicia-bearing surfaces. In a preferred embodiment, wherein the panel 1000 is an inner panel of a tripartite composite tag having two outer panels as described herein, both opposite surfaces of the inner panel are treated or powder coated to make it easier to slide both outer panels relative to the inner panel, and both inner panel surfaces are also preferably treated to form writing surfaces thereon. Powder coating or similar coatings also prevent possible galvanic corrosion that might exist between a pair of un-coated magnetic surfaces and/or metallic surfaces, particularly in humid or wet conditions. Alternatively, the panel may already be provided with a treated outer surface, or the material used to make the panel may be configured such that it is already provided with stain-resistant surfaces or surfaces that resist the absorption of ink or writing.

Various devices 1040 may be used to produce a writing surface 1050 that is configured to accept the absorption of a writing material, ink or the like. In one embodiment, the device 1040 is a sandblaster that removes a portion or portions of the coated surface 1030 to form a writing surface 1050. A sandblaster is a commonly used machine that can produce a relatively uniform surface roughness on a broad range of surfaces. When using a sandblaster, the area being modified may need to be restricted via some means of controlling the abrasive particles in the blast such that they only impinge on the area in which it is desirable to have the roughened surface. This necessitates the use of a finely controlled flux of abrasive or the use of a mask that is positioned such that only the desired region is exposed to the abrasive from the sandblaster. While this approach works, it may not preferable in certain situations due to the need to protect the unaltered regions of the coated surface 1030.

In another embodiment, the device 1040 is a laser powerful enough to change the surface texture of the surface being modified, or in the embodiment of FIGS. 20A-20C, the coated surface 1030. In one embodiment, the laser is a laser engraver that might include support systems (not shown) that facilitate the rapid manipulation of the panel to alter the coated surface pursuant to a controller and a controlled solution. Laser engravers are particularly suited to creating intricate indicia based on the ease with which the energy profile of the laser can be shaped and flexibly delivered to the surface so as to alter the surface of the panel that is made from or coated with a broad range of materials including, but not limited to low porosity coatings, coated metal, coated plastic, or any surface supporting a coating that doesn't accept common inks from writing implements. In addition to low porosity coated surfaces there also exists a range of materials, for example smooth or polished metals, glass, polyoxymethylene such as DuPont's Delrin®, that in their uncoated state don't readily accept inks from writing implements. The device 1040 could also be used on panels formed from such coated surfaces to create altered surfaces 1050 that more readily accept inks.

Laser engravers utilize a range of different technologies and are available with a very broad selection of laser types, each potentially operating at a unique wavelength or optical frequency, power level, intensity, modulation frequency, mode quality, power profile, wavefront, and/or any number of parameters attributed to a particular laser type. There exist a number of connections between the type and configuration of the laser source and the effectiveness of the overall laser engraver in its ability to alter the surface and/or subsurface properties of a panel or panel surface.

In addition to a large number of possible laser sources that can be utilized within a laser engraver, there also exists a large number of optical devices that can be used to shape, or in some way alter the laser light field as it propagates from the laser source to the panel to be treated. There also exist a number of different ways to provide fine control over how the panel is exposed to the laser radiation. For example, various motorized elements might be used from motor driven mirrors that can deflect the laser beam as a means of controlling how the laser light interacts with the piece part, or the laser may remain fixed while the piece part is moved via a motorized stage operating so as to control the exposure of the panel part to the laser radiation. Alternatively some combination of moving mirrors and moving panel parts could be utilized.

An objective lens is often used in a laser engraver to control the intensity of the light on the panel, this objective lens might be a fixed element or it might be motorized or in some way automated or changeable so as to effect the irradiation of the panel by the light source. It is noted that the laser beam delivered to the panel might be round, or it might be rectangular or elliptical or any shape determined to improve the performance of the laser engraver for a particular application. In addition to choosing, controlling, or modifying the broad range of laser engraver characteristics or configurations, the user of a laser engraver may choose to apply a material or substance to the piece part before irradiating it with laser light so as to enhance the performance of the laser engraver as it operates to alter the surface or subsurface of a panel.

In the embodiment of FIGS. 20A-20C with a powder-coated surface 1030 acted upon by a laser device 1040, as the optical intensity required to alter the powder coat surface 1030 of the panel 1000 is substantially lower than that required to alter the surface of, for example, a 18-8 stainless steel part that has not been powder coated, it is understood that for the powder coated panel, many commercial laser engravers designed to engrave metal or plastic parts can be used. It is preferable, in order to alter the powder coated surface 1030, to ensure that the laser power can be attenuated enough so as to have a controlled alteration of the powder coat such that the roughened surface has the desired aesthetics and is configured to absorb inks.

It should be appreciated that there are a multitude of devices 1040 that could be used in place of the sandblaster and laser engraver described herein, for example the laser in the laser engraver could be replaced with a high intensity lamp provided the lamp and corresponding laser engraver elements are adapted to ensure sufficient energy is delivered to the panel part so as to alter the surface. Aside from a laser engraver, a mechanical scribe such as, but not limited to a shape metal, diamond, or other hard surface, could be used to abrade or roughen the surface, preferably under mechanized or computer control. In place of the scribe, a small rotating sandpaper disc could be used to create the roughened surface that would more permanently accept the ink of a permanent marker such as a Sharpie®. Alternatively, a chemical etching process could be used to prepare the surface for writing. In an alternative embodiment, a printed surface may be formed not by removing a portion or portions of material from the outer surface, but by instead applying a writing surface onto the powder-coated surface 1030 such as by, for example, applying via printing or silk screen printing a writeable area onto the panel. Such silk screening may be used to create a porous matte pad area for receiving ink and writing of various types and instruments.

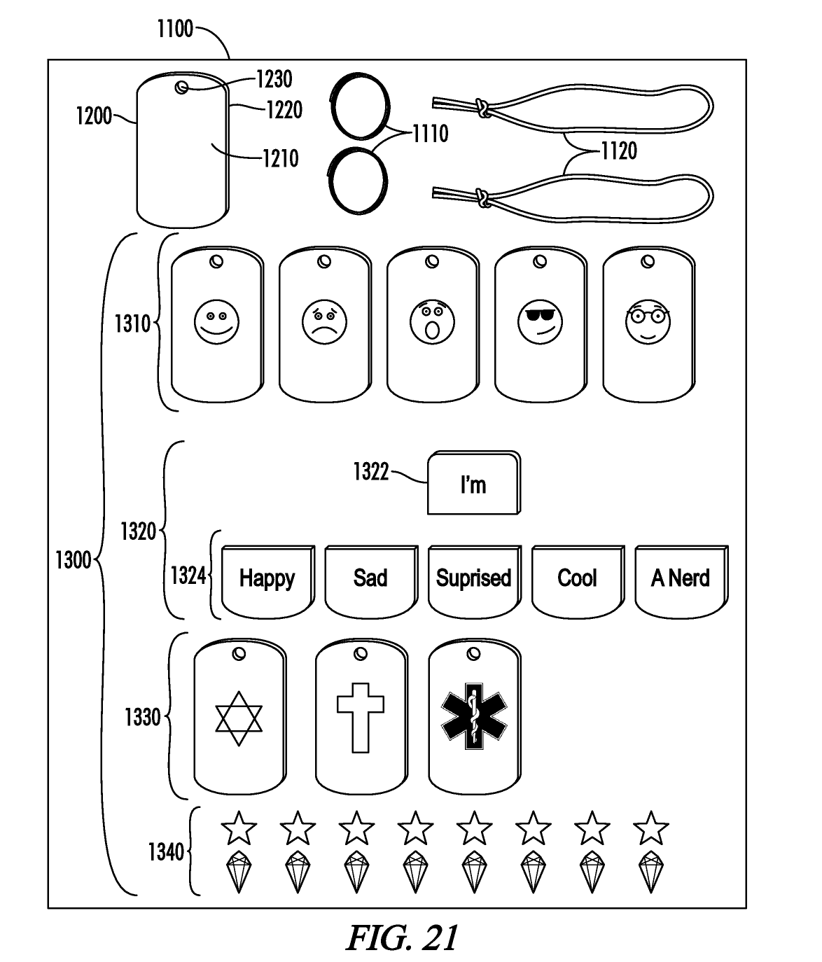

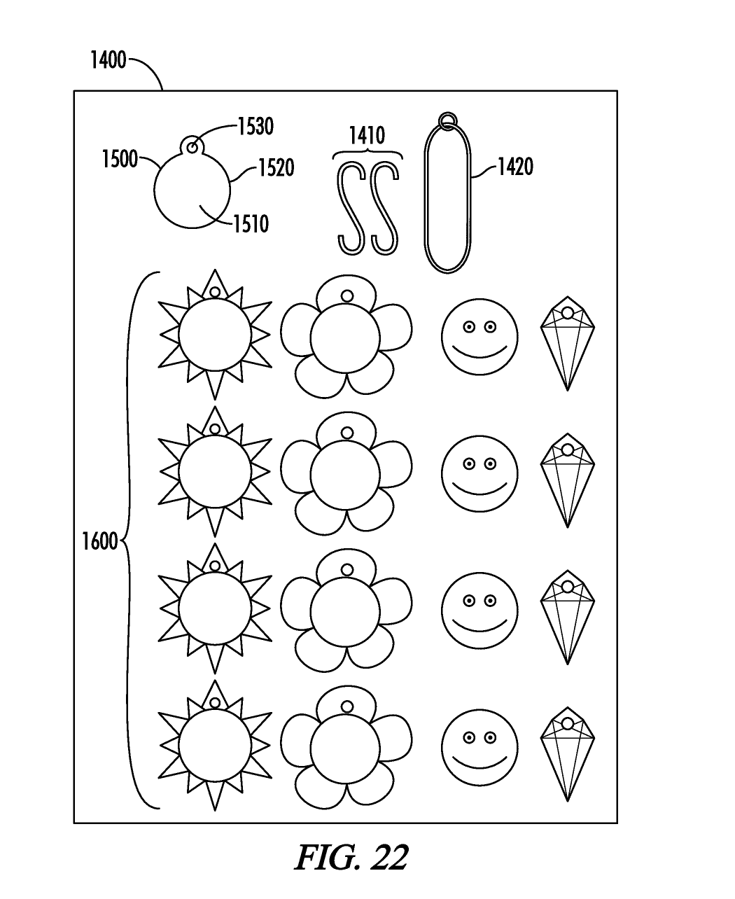

FIG. 21 illustrates one embodiment of a kit 1100 comprising an embodiment of an inner panel 1200 and a plurality of interchangeable replaceable outer panels 1300 that can be attached on the first and/or second surfaces 1210, 1220 of the inner panel 1200. While only one inner panel 1200 is shown, it will be appreciated that multiple inner panels 1200 may be provided to create multiple composite tags. The outer panels 1300 can assume a variety of different shapes, sizes, configurations and each can have a variety of different decorative, creative, and/or identifying indicia provided thereon. While the kit 1100 shows only certain inner and outer panels, it will be appreciated that a kit may include any of the inner and outer panels described herein, or combinations of panels described herein and other panels not described herein. For example, in the embodiment of the kit 1100 of FIG. 21 there might be provided outer panels 1310 comprising various facial expressions that can be attached to the inner panel 1200 as desired. Similarly, there might be provided outer panels 1320 formed from a variety of panel segments incorporating different sayings 1322, 1324 that may be attached to the inner panel 1200 independently of or in combination with the outer panels 1310. For example, a smiley face outer panel 1310 may be attached to the first surface 1210 of the inner panel 1200 and panel segments 1322, 1324 that state “I'm” and “Happy” may be attached to the second surface 1220 of the inner panel 1200. Other panels 1330 may be provided to identify a user's condition or religious persuasion or other types of identifying indicia may be provided. Other panels 1340 may be provided to decorate the inner panel 1200 as desired. Other panels may provide additional functional benefits, such as panels that incorporate mirrors, cosmetic mirrors, magnifying mirrors, lenses, magnifying lenses, illumination devices, sound devices including speakers, tools, and office supply instruments such as card-based scissors, rulers, letter openers and the like. Other functional features may be incorporated into the panels as desired. An opening 1230 in the inner panel 1200 may accommodate various carrying members, such as key rings 1110 or straps 1120, or the like.

FIG. 22 illustrates one embodiment of a kit 1400 comprising an embodiment of an inner panel 1500 and a plurality of interchangeable outer panels 1600 that can be attached on the first and/or second surfaces 1510, 1520 of the inner panel 1500. While only one inner panel 1500 is shown, it will be appreciated that multiple inner panels 1500 may be provided to create multiple composite tags. In the embodiment of FIG. 22, the inner panel 1500 is formed as a piece of jewelry to which can be attached various outer panels 1600 or combinations of outer panels. An opening 1530 in the inner panel 1500 may accommodate various carrying members, such as earring hooks 1410 or a chain 1420 that is sized and configured to create a bracelet or a necklace to be worn around a user's wrist or neck, or the like.

FIGS. 23-25 illustrate various non-limiting embodiments of a composite tag that are held together and carried without the use of an opening or openings in the tag panels as described in connection with some of the tag embodiments described herein. FIG. 23 illustrates one embodiment of a composite tag 50h having an inner panel 100h and outer panels 200h, 300h that are retained by one embodiment of a carrying member 400h including a strap 410h adapted to be worn or carried by a user and a clamp 420h having free ends 430h for engagement with the tag 50h. In the embodiment of FIG. 23, the free ends 430h attach to the outer surfaces 220h, 320h of the panels 200h, 300h and compressively hold the tag 50h without the need for openings in the panels. In the embodiment of FIG. 23, the outer surfaces 220h, 320h are preferably not magnetic. In the embodiment of FIG. 24, the outer surfaces 220i, 320i of tag 50i may be provided with indicia or markings 222i that serve as a guide for attachment of the free ends 430i to the outer surfaces 220i, 320i of the panels 200i, 300i, with the inner panel 100i being sandwiched between the outer panels 200i, 300i. In the embodiment of FIG. 25, the outer surfaces 220j, 320j of tag 50j may be provided with surface features such as a depression 222j that serve as a guide for attachment of the free ends 430j to the outer surfaces 220j, 320j of the panels 200j, 300j, with the inner panel 100j being sandwiched between the outer panels 200j, 300j. Any of the panels described herein may be used as the panels described in the embodiments of FIGS. 23-25, any of which may be interchangeable as desired as also described in the various embodiments discussed herein.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A composite tag, comprising:
a) a first inner panel having a first surface and a second surface;
b) a second outer panel having an inner surface and an outer surface and being magnetically attached to the first surface of the first inner panel;
c) a third outer panel having an inner surface and an outer surface and being magnetically attached to the second surface of the first inner panel; and
d) an opening in at least one of the panels for receiving a carrying member;
e) wherein the first inner panel substantially conforms to the size and shape of the two outer panels.

2. The composite tag of claim 1, further comprising an opening in each panel that cooperatively aligns with the other openings in the other panels when the panels are attached to form a passage through the panels for receiving a carrying member.

3. (canceled)

4. The composite tag of claim 1, wherein the opening is disposed along a lateral axis of the panel.

5. (canceled)

6. (canceled)

7. The composite tag of claim 1, wherein the inner surfaces of the second and third panels are magnetic and the outer surfaces are not magnetic.

8. The composite tag of claim 1, wherein at least a portion of the first or second surface of at least one of the panels further comprises a coating.

9. The composite tag of claim 8, wherein the coating is a powder coating.

10. The composite tag of claim 9, further comprising a writing surface formed into the powder coating.

11. The composite tag of claim 10, further comprising a writing surface formed by the removal of a portion or portions of the powder coating.

12. The composite tag of claim 11, wherein at least a portion of the first and second surface of the at least one of the panels further comprises a coating.

13. The composite tag of claim 1, further comprising a writing surface configured to absorb or enhance the adhesion of a marking material formed into or formed onto one of the surfaces of one of the panels.

14. The composite tag of claim 13, wherein the writing surface is formed by removing a portion or portions of one of the surfaces of one of the panels.

15. The composite tag of claim 13, wherein the writing surface is applied onto one of the surfaces of one of the panels.

16. (canceled)

17. The composite tag of claim 1, wherein the first inner panel is rigid and the second and third outer panels are either rigid or flexible or a combination of the same.

18. The composite tag of claim 17, wherein the first inner panel is rigid and the second and third outer panels are flexible.

19. (canceled)

20. (canceled)

21. (canceled)

22. (canceled)

23. (canceled)

24. (canceled)

25. (canceled)

26. (canceled)

27. A method of making a composite tag, comprising:
a) providing a first inner panel having a first surface and a second surface;
b) providing a second outer panel having an inner surface and an outer surface and being attachable to the first surface of the first inner panel;
c) providing a third outer panel having an inner surface and an outer surface and being attachable to the second surface of the first inner panel; and
d) attaching the second and third outer panels to the first inner panel to form a composite tag.

28. The method of claim 27, further comprising forming a writing surface on at least one of the panels by removing a portion of at least one of the first or second surfaces of the at least one of the panels or by applying the writing surface onto a portion of at least one of the first or second surfaces of the at least one of the panels.

29. (canceled)

30. The method of claim 27, further comprising magnetically attaching the second and third outer panels to the first inner panel.

31. (canceled)

32. The method of claim 28, wherein the removing is achieved by laser engraving, laser marking, or laser etching a portion of the at least one of the first or second surfaces.

33. (canceled)

34. (canceled)

35. (canceled)

36. (canceled)

37. (canceled)

38. (canceled)

39. (canceled)

40. (canceled)

41. (canceled)

42. A composite magnetic tag, comprising:
a) two magnetic outer panels, consisting of a first outer panel and a second outer panel, and a central ferromagnetic plate;
b) wherein each of the magnetic outer panels has a magnetic interior side and an exterior side that contains one or more indicia;
c) wherein the central ferromagnetic plate is a plate made of ferromagnetic metal, which substantially conforms to the size and shape of the two magnetic outer panels;
d) wherein each of the two magnetic outer panels attaches by its magnetic interior side to either face of the central ferromagnetic plate, thereby assembling a composite tag, in which the central ferromagnetic plate is sandwiched between the two magnetic outer panels, such that the indicia on the exterior sides of the magnetic outer panels are visible; and
e) wherein the first outer panel has an aperture which aligns cooperatively with a corresponding aperture of the second outer panel and a corresponding aperture of the central ferromagnetic plate, such that a composite aperture is formed when the composite tag is assembled, and such that the assembled composite tag can be attached to one or more items by a connective means inserted through the composite aperture.

43. The composite magnetic tag of claim 42, wherein the magnetic outer panels are interchangeable with one or more replacement panels having the same form and structure as the magnetic outer panels but containing alternate indicia that differ from the indicia of the magnetic outer panels.

44. (canceled)

45. (canceled)

46. (canceled)

47. (canceled)

48. (canceled)

49. (canceled)

50. (canceled)

51. (canceled)
